(19) United States
(12) Patent Application Publication
(10) Pub. No.: US 2023/0302440 A1
(43) Pub. Date: Sep. 28, 2023

(54) METAL RATIO INSPECTION METHOD, METHOD FOR PRODUCING ELECTRICALLY HEATING CATALYST, AND METHOD FOR PRODUCING HONEYCOMB STRUCTURE

(71) Applicant: NGK Insulators, Ltd., Nagoya-City (JP)

(72) Inventors: Rina YOKOI, Aisai-City (JP); Takashi NORO, Nagoya-City (JP); Takamichi SATO, Chita-City (JP)

(73) Assignee: NGK Insulators, Ltd., Nagoya-City (JP)

(21) Appl. No.: 18/184,754

(22) Filed: Mar. 16, 2023

(30) Foreign Application Priority Data
Mar. 22, 2022 (JP) 2022-046047
Jan. 23, 2023 (JP) 2023-008297

(51) Int. Cl. B01J 37/34; G06T 7/00; B01J 35/04

(52) U.S. Cl. CPC B01J 37/342; G06T 7/0004; B01J 35/04; G06T 2207/30136

(57) ABSTRACT

A metal ratio inspection method for inspecting a metal ratio of a thermally sprayed composite material containing at least one metal and at least one ceramic, the method includes: an imaging step (step S11) of imaging the thermally sprayed composite material while irradiating the thermally sprayed composite material with imaging light; and an estimating step (step S12) of estimating a metal ratio of the thermally sprayed composite material based on a luminance distribution of the image of the thermally sprayed composite material obtained in the imaging step.

### FIELD OF THE INVENTION

The present invention relates to a metal ratio inspection method for inspecting a metal ratio of a thermally sprayed composite material containing metals and ceramics, as well as a method for producing an electrically heating catalyst and a method for producing a honeycomb structure, using that method.

### BACKGROUND OF THE INVENTION

In general, composite materials including metals and ceramics are thermally sprayed. Patent Literature 1 below discloses that electrode layers provided on a honeycomb structure and metal electrodes are joined by a thermally sprayed composite material.

Properties of the thermally sprayed composite material, such as volume resistivity, depend on a metal ratio of the thermally sprayed composite material. A conventional method for inspecting the metal ratio of the thermally sprayed composite material includes obtaining an SEM (scanning electron microscope) image of a cut end surface of the thermally sprayed composite material and then calculating a metal ratio of the thermally sprayed composite material from a contrast difference in the SEM image.

Patent Literature 2 below proposes to take image of appearances of ceramic parts and detect internal cracks in the ceramic parts from a luminance difference in the taken images, although it is not an inspection of the metal ratio of thermally sprayed composite material.

### CITATION LIST

### Patent Literatures

[Patent Literature 1] Japanese Patent Application Publication No. 2012-106164 A
[Patent Literature 2] Japanese Patent Application Publication No. 2002-318195 A

### SUMMARY OF THE INVENTION

In the conventional method for inspecting the metal ratio as described above, the metal ratio of the thermally sprayed composite material is calculated from the SEM images. In order to obtain the SEM images, the method requires a complicated operation, namely cutting the thermally sprayed composite material, embedding the cut pieces in a resin to form samples, and observing the samples with the SEM. Also, in order to obtain the SEM images, it is also necessary to destroy the thermally sprayed composite material to be inspected. Further, it is difficult to inspect a plurality of thermally sprayed composite materials simultaneously, due to the observation field limit of the SEM.

The present invention has been made to solve at least one of the above problems. One of objects of the present invention is to provide a metal ratio inspection method, a method for producing an electrically heating catalyst, and a method for producing a honeycomb structure, which can more easily inspect a metal ratio of a thermally sprayed composite material.

### Aspect 1.

In an embodiment, the present invention relates to a metal ratio inspection method for inspecting a metal ratio of a thermally sprayed composite material comprising at least one metal and at least one ceramic, the method comprising: an imaging step of imaging the thermally sprayed composite material while irradiating the thermally sprayed composite material with imaging light; and an estimating step of estimating a metal ratio of the thermally sprayed composite material based on a luminance distribution of the image of the thermally sprayed composite material obtained in the imaging step.

### Aspect 2.

The present invention may relate to the metal ratio inspection method according to Aspect 1, wherein in the imaging step, an irradiation angle of the imaging light to the thermally sprayed composite material is 30° to 90°.

### Aspect 3.

The present invention may relate to the metal ratio inspection method according to Aspect 1 or 2, wherein an illuminance of the imaging light is 750,000 lux to 1,500,000 lux in the imaging step.

### Aspect 4.

The present invention may relate to the metal ratio inspection method according to any one of Aspects 1 to 3, wherein the thermally sprayed composite material comprises thermally sprayed fixed layers for fixing metal electrodes to the honeycomb structure.

### Aspect 5.

The present invention may relate to the metal ratio inspection method according to any one of Aspects 1 to 4, wherein the thermally sprayed composite material comprises thermally sprayed underlayers formed on an outer peripheral surface of a honeycomb structure.

### Aspect 6.

The present invention may relate to the metal ratio inspection method according to any one of Aspects 1 to 5, wherein the metal ratio inspection method further comprises a determination step of determining whether the metal ratio estimated in the estimation step is in a predetermined range.

### Aspect 7.

The present invention relates to a method for producing an electrically heating catalyst, the method comprising: a preparation step of preparing an electrically heating catalyst having metal electrodes fixed by thermally sprayed fixed layers comprising at least one metal and at least one ceramic; an inspection step of inspecting the metal ratio of the thermally sprayed fixed layer by the metal ratio inspection method according to any one of Aspects 1 to 5; and an electrically heating catalyst selection step of selecting an electrically heating catalyst having a metal ratio of the thermally sprayed fixed layer in a predetermined range based on inspection results of the inspection step.

### Aspect 8.

The present invention relates to a method for producing a honeycomb structure, the method comprising: a preparation step of preparing a honeycomb structure, the honeycomb structure having thermally sprayed underlayers comprising at least one metal and at least one ceramic, each of the thermally sprayed underlayer being formed on an outer peripheral surface of the honeycomb structure; a first inspection step of inspecting a metal ratio of the thermally sprayed underlayer by the metal ratio inspection method according to any one of Aspects 1 to 5; and a honeycomb structure selection step of selecting a honeycomb structure having a metal ratio of the thermally sprayed underlayer in a predetermined range based on inspection results of the first inspection step.

### Aspect 9.

The present invention may relate to the method for producing a honeycomb structure according to Aspect 8, wherein the honeycomb structure selection step comprises selecting a honeycomb structure having a metal ratio of the thermally sprayed underlayer in a range of 20 to 80%.

### Aspect 10.

The present invention relates a method for producing an electrically heating catalyst, the electrically heating catalyst having metal electrodes fixed onto a honeycomb structure obtained by a method for producing the honeycomb structure, the method for producing the honeycomb structure comprising: a preparation step of preparing a honeycomb structure having thermally sprayed underlayers comprising at least one metal and at least one ceramic, each of the thermally sprayed underlayers being formed on an outer peripheral surface of the honeycomb structure; a first inspection step of inspecting a metal ratio of the thermally sprayed underlayer; a honeycomb structure selection step of selecting a honeycomb structure having a metal ratio of the thermally sprayed underlayer in a predetermined range based on inspection results of the first inspection step, wherein the method for producing an electrically heating catalyst comprises: a fixing step of fixing the metal electrodes to the thermally sprayed underlayers by thermally sprayed fixed layers comprising at least one metal and at least one ceramic in the selected honeycomb structure after the honeycomb structure selection step; a second inspection step of inspecting the metal ratio of the thermally sprayed fixed layer; and an electrically heating catalyst selection step of selecting an electrically heating catalyst having a metal ratio of the thermally sprayed fixed layer in a predetermined range based on inspection results of the second inspection step, and wherein the first and second inspection steps are performed by the metal ratio inspection method according to any one of Aspects 1 to 5.

### Aspect 11.

The present invention may relate to the method for producing an electrically heating catalyst according to Aspect 7 or 10, wherein the electrically heating catalyst selection step comprises selecting an electrically heating catalyst having a metal ratio of the thermally sprayed fixed layer in a range of 20 to 80%.

According an embodiment of the metal ratio inspection method, the method for producing an electrically heating catalyst, and the method for producing a honeycomb structure, the metal ratio of the thermally sprayed composite material can more easily be inspected.

### BRIEF DESCRIPTION OF THE DRAWINGS

FIG. 1 is a flow chart showing a metal ratio inspection method according to an embodiment of the present invention;

FIG. 2 is a perspective view showing a honeycomb structure as an example of an object to be inspected by the method of FIG. 1;

FIG. 3 is a plane view showing metal electrodes fixed to the honeycomb structure of FIG. 2;

FIG. 4 is a perspective view showing the thermally sprayed fixed layer of FIG. 3 and its surroundings;

FIG. 5 is a plane view showing an example of an inspection device capable of implementing the method of FIG. 1;

FIG. 6 is a side view showing the inspection device of FIG. 5;

FIG. 7 is a plane view of a first variant of an inspection device capable of implementing the method of FIG. 1;

FIG. 8 is a side view showing the inspection device of FIG. 7;

FIG. 9 is a plane view of a second variant of an inspection device capable of implementing the method of FIG. 1;

FIG. 10 is a side view showing the inspection device of FIG. 9;

FIG. 11 is a plane view of a third variant of an inspection device capable of implementing the method of FIG. 1;

FIG. 12 is a side view showing the inspection device of FIG. 11;

FIG. 13 is a flow chart showing a method for producing an electrically heating catalyst according to an embodiment of the present invention;

FIG. 14 is a flow chart showing a method for producing a honeycomb structure according to an embodiment of the present invention; and

FIG. 15 is a flow chart showing a method for producing an electrically heating catalyst according to an embodiment of the present invention.

### DETAILED DESCRIPTION OF THE INVENTION

Hereinafter, embodiments for carrying out the present invention will be described with reference to the drawings. The present invention is not limited to each embodiment, and components can be modified and embodied without departing from the spirit of the present invention. Further, various inventions can be formed by appropriately combining a plurality of components disclosed in each embodiment. For example, some components may be removed from all of the components shown in the embodiments. Furthermore, the components of different embodiments may be optionally combined.

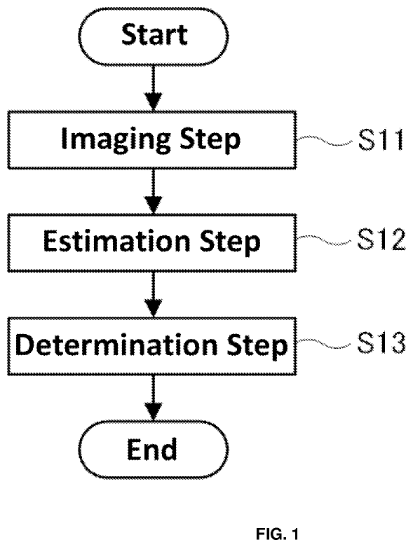

FIG. 1 is a flow chart showing a metal ratio inspection method according to an embodiment of the present invention. The metal ratio inspection method according to the present embodiment is for inspecting a metal ratio of a thermally sprayed composite material containing at least one metal and at least one ceramic.

The thermally sprayed composite material is formed by spraying a molten material onto a predetermined target. As will be described later with reference to drawings, the thermally sprayed composite material may include thermally sprayed fixed layers for fixing metal electrodes to a honeycomb structure, and thermally sprayed underlayers formed on an outer peripheral surface of the honeycomb structure. However, the thermally sprayed composite material is not limited thereto, and it may be any material containing at least one metal and at least one ceramic.

The metal ratio of the thermally sprayed composite material refers to a ratio of metal components contained in the thermally sprayed composite material. More specifically, the metal ratio of the thermally sprayed composite material can be a ratio of an area of the metal components to an area of the entire observation portion of the thermally sprayed composite material. Also, the metal ratio of the thermally sprayed composite material may be a percent by weight or a percent by volume of the metal components in the thermally sprayed composite material. The percent by weight or the percent by volume may be converted from other numerical values such as an area ratio of the metal components.

As shown in FIG. 1, the metal ratio inspection method according to the present embodiment includes an imaging step (step S11) and an estimation step (step S12).

The imaging step (step S11) is a step of imaging the thermally sprayed composite material while irradiating the thermally sprayed composite material with imaging light. In the imaging step, an image of the thermally sprayed composite material (an image of an external appearance of the thermally sprayed composite material) is obtained. The image may show only one thermally sprayed composite material, but it may also show multiple thermally sprayed composite materials. The image may show other members (background), such as a surface of the honeycomb structure on which the thermally sprayed composite material is mounted. However, a part of one thermally sprayed composite material may occupy the entire image. For a particular thermally sprayed composite material, one image of the thermally sprayed composite material taken from one angle may be obtained, or multiple images of the thermally sprayed composite material taken from multiple angles may be obtained. The multiple images of a particular surface of the particular thermally sprayed composite material taken from multiple angles may be obtained. For example, when the thermally sprayed composite material is a thermally sprayed underlayer as described below, multiple images of a particular thermally sprayed underlayer taken from different directions may be obtained. Further, when the thermally sprayed composite material is a thermally sprayed underlayer as described below, multiple images of an outer surface of the thermally sprayed underlayer taken from different directions may be obtained. When the multiple images are obtained for the particular thermally sprayed composite material, the images may be merged to obtain a three-dimensional shape of that thermally sprayed composite material. The image may be a still image or a moving image (a plurality of still images continuously captured). If necessary, the imaging range and/or image type (still image or moving image) may be switched.

The irradiation of the thermally sprayed composite material with the imaging light can be performed under various conditions. The imaging light may be direct light directly emitted from a light emitting means onto the thermally sprayed composite material. When the imaging light is the direct light, an irradiation angle of the imaging light to the thermally sprayed composite material can be 30° to 90°, although not limited thereto. The irradiation angle of 30° or more and 90° or less leads to easy detection of the imaging light reflected by the thermally sprayed composite material by means of an imaging device or a camera, so that a difference in metal ratio can be easily determined. The irradiation angle is understandable as an angle formed by the imaging light and a front surface of a sample. The position of the imaging light may be understandable as the position of the light emitting means. The sample may be understandable as the thermally sprayed composite material itself, but it may also be understandable as a member (for example, a honeycomb structure) provided with the thermally sprayed composite material. The front surface of the sample may be understandable as a surface of the thermally sprayed composite material to be imaged. On the other hand, when the sample is the member provided with the thermally sprayed composite material, the front surface of the sample may be understandable as a tangent plane of the member at the position where the thermally sprayed composite material is provided. On the other hand, the imaging light may be indirect light or diffused light that is indirectly applied from the light emitting means to the thermally sprayed composite material via a reflecting member or a diffusing member. An illuminance of the imaging light is not limited, but it may be 750,000 lux to 1,500,000 lux. When the illuminance is 750,000 lux or more, the thermally sprayed composite material can be imaged under a sufficient amount of light, resulting in easy determination of the difference in the metal ratio. When the illuminance is 1,500,000 lux or less, it is possible to avoid overexposure of the image due to an excessive amount of light, resulting in easy determination of the difference in the metal ratio. The illuminance of the imaging light can be measured using, for example, an illuminometer or the like, at the position of the thermally sprayed composite material.

The estimation step (step S12) is a step of estimating the metal ratio of the thermally sprayed composite material based on a luminance distribution of the image of the thermally sprayed composite material obtained in the imaging step.

As described above, the thermally sprayed composite material contains at least one metal and at least one ceramic. The metal reflects more imaging light than the ceramic. For this reason, a difference appears in the luminance distribution of the image depending on the metal ratio of the thermally sprayed composite material. The higher the metal content of the thermally sprayed composite material, the more areas of high illuminance. A plurality of images of thermally sprayed composite materials with known metal ratios can be obtained, and the illuminance distribution of those images can be obtained in advance as a reference distribution. By comparing the illuminance distribution of the image of the thermally sprayed composite material obtained in the imaging step with the reference distribution, the metal ratio of the thermally sprayed composite material in the image can be estimated.

When the image obtained in the imaging step includes objects other than the thermally sprayed composite material (background), for example, the thermally sprayed composite material portion is cut out from the image by image processing such as edge detection, and the luminance distribution can be then obtained from that thermally sprayed composite material portion. When the image obtained in the imaging step includes a plurality of thermally sprayed composite materials, the luminance distribution in each thermally sprayed composite material portion can be obtained. The luminance distribution is understandable as a histogram of reflected light. The luminance distribution may be a distribution of luminance values for each pixel of an image, or may be a distribution of luminance values for each region containing a plurality of pixels adjacent to each other. The luminance value of the region may be an average value of luminance values of a plurality of pixels included in the region. When the multiple images are obtained for the particular thermally sprayed composite material, a result of individually estimated metal ratio of each image may be obtained, or an average value of the metal ratios of the respective images may be obtained as a final metal ratio result.

As shown in FIG. 1, the metal ratio inspection method according to the present embodiment further includes a determination step (step S13) of determining whether the metal ratio estimated in the estimation step is in a predetermined range. The range of the metal ratio used for determination can be appropriately set for each object to be inspected. For example, when the thermally sprayed composite material is a thermally sprayed fixed layer for fixing the metal electrodes to the honeycomb structure, or a thermally sprayed underlayer formed on the outer peripheral surface of the honeycomb structure, the range of the metal ratio used for determination may be set to a range of 20 to 80%.

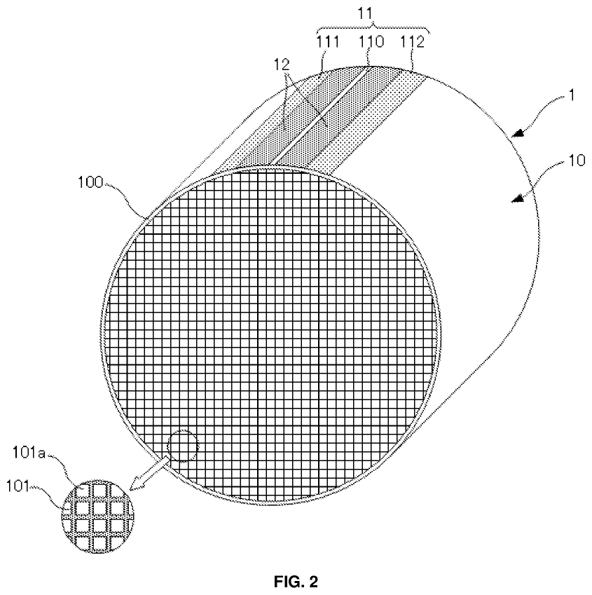

Next, FIG. 2 is a perspective view showing a honeycomb structure 1, which is an example of an object to be inspected by the method of FIG. 1. The honeycomb structure 1 shown in FIG. 2 forms a part of an electrically heating support. The electrically heating support can generate heat in the honeycomb structure 1 by electrical conduction to increase a temperature of a catalyst supported on the honeycomb structure 1 to its activation temperature before starting an engine. The electrically heating support is provided, for example, on an exhaust path of an automobile or the like, and can be used to purify an exhaust gas discharged from the engine.

The honeycomb structure 1 has a honeycomb structure portion 10, a pair of electrode layers 11 and a pair of thermally sprayed underlayers 12.

The honeycomb structure portion 10 is a pillar shaped member made of ceramics, and includes: an outer peripheral wall 100; and a partition wall 101 which is arranged on an inner side of the peripheral wall 100 and defines a plurality of cells 101a each extending from one end face to other end face to form a flow path. The pillar shape is understandable as a three-dimensional shape having a thickness in a flow path direction of the cells 101a (axial direction of the honeycomb structure portion 10). A ratio of an axial length of the honeycomb structure portion 10 to a diameter or width of the end face of the honeycomb structure portion 10 (aspect ratio) is arbitrary. The pillar shape may include a shape in which the axial length of the honeycomb structure portion 10 is shorter than the diameter or width of the end face (flat shape).

The pair of electrode layers 11 are provided on the surface of the outer peripheral wall 100. The pair of electrode layers 11 are provided to be spaced apart from each other in the circumferential direction of the honeycomb structure portion 10. More particularly, the pair of electrode layers 11 are provided across the central axis of the honeycomb structure 10. In FIG. 2, only one of the pair of electrode layers 11 is shown.

The electrode layers 11 are provided in order to facilitate the flow of electricity. The volume resistivity of the electrode layers 11 is preferably 1/200 or more and 1/10 or less of the volume resistivity of the honeycomb structure portion 10. Each electrode layer 11 may be made of a conductive ceramic, a metal, or a composite material (cermet) of a metal and a conductive ceramic. Examples of the metal include a single metal of Cr, Fe, Co, Ni, Si or Ti, or an alloy containing at least one metal selected from the group consisting of those metals. Non-limiting examples of the conductive ceramics include silicon carbide (SiC), and metal compounds such as metal silicides such as tantalum silicide (TaSi₂) and chromium silicide (CrSi₂).

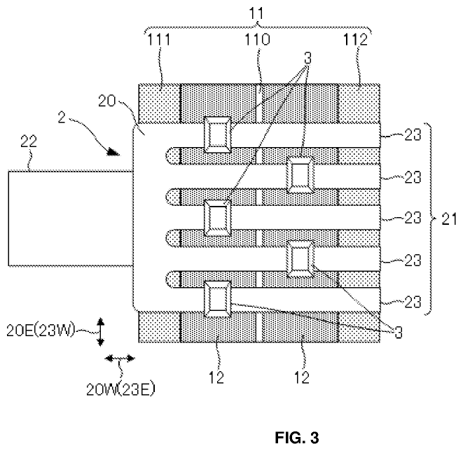

As will be described later, in the electrically heating support according to the present embodiment, metal electrodes 2 (see FIG. 3) are fixed on the electrode layers 11. Although not shown, the metal electrodes 2 can be connected to an external power source such as a battery via a power cable. By applying a voltage to the honeycomb structure 10 through the metal electrodes 2 and the electrode layers 11, the honeycomb structure 10 can generate heat.

Each of the pair of electrode layers 11 according to this embodiment has: a separator 110; and first and second partial electrode layers 111, 112 separated by the separator 110. The separator 110 may be a slit provided between the first and second partial electrode layers 111,112. The slit may be filled with a material having a higher volume resistivity than that of each of the first and second partial electrode layers 111, 112.

The pair of thermally sprayed underlayers 12 are provided to improve the adhesion of thermally sprayed fixed layers 3 (see FIG. 3) that fix the metal electrodes 2 to the electrode layers 11, and are formed on the respective electrode layers 11. FIG. 2 shows only one of the pair of thermally sprayed underlayers 12. The thermally sprayed underlayers 12 form the thermally sprayed composite material containing at least one metal and at least one ceramic. Materials for the thermally sprayed underlayers 12 include composites of metal silicon and silicon carbide, composites of metal silicide such as tantalum silicide and chromium silicide, metal silicon and silicon carbide, and composite materials obtained by adding to one or more metals as described above one or more insulating ceramics such as alumina, mullite, zirconia, cordierite, silicon nitride, bentonite and aluminum nitride in terms of reducing thermal expansion. The metals that can be used herein, other than the above metals, include heat-resistant metals such as metals containing Al or Cr, SUS, or Ni—Cr alloys, and the like. The thermally sprayed underlayers 12 may be omitted.

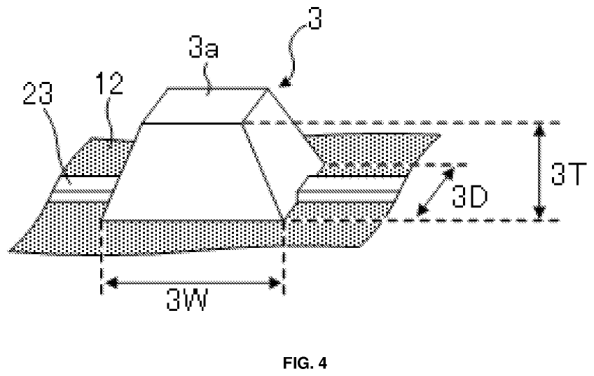

Next, FIG. 3 is a plane view showing the metal electrode 2 fixed to the honeycomb structure 1 of FIG. 2, and FIG. 4 is a perspective view showing the thermally sprayed fixed layer 3 of FIG. 3 and its surroundings. The electrically heating support according to the present embodiment includes the honeycomb structure 1 as described above, a pair of metal electrodes 2 for applying a voltage to the honeycomb structure 1, and a plurality of thermally sprayed fixed layers 3 for fixing the pair of metal electrodes 2 to the honeycomb structure 1. FIG. 3 shows a main part of the electrically heating support according to an embodiment of the present invention, illustrating a state where one metal electrode 2 is fixed to one electrode layer 11. The other metal electrode 2 is fixed in the same manner to the other electrode layer 11. One of the pair of metal electrodes 2 is used as a positive electrode and the other is used as a negative electrode. That is, the current flows from one metal electrode 2 through the honeycomb structure 1 to the other metal electrode 2.

Each of the pair of metal electrodes 2 is provided with a base portion 20, a connection portion 21 and a drawer portion 22. The base portion 20, the connection portion 21, and the drawer portion 22 can be formed of plates. At least the base portion 20 and the connection portion 21 are arcuate so as to be along the outer peripheral surface of the honeycomb structure 1 or can be arcuate.

The base portion 20 is provided integrally with the connection portion 21 and the drawer portion 22. The base portion 20 is arranged between the connection portion 21 and the drawer portion 22. The base 20 can be an elongated plate. Each of the metal electrodes 2 can be arranged on the outer peripheral surface of the honeycomb structure 1 such that an extending direction 20E (longitudinal direction) of the base portion 20 is along the flow path direction of the cells 101a. In this case, a width direction 20W of the base portion 20 orthogonal to the extending direction 20E can extend in the circumferential direction of the honeycomb structure 1. Each of the metal electrodes 2 may be arranged on the outer peripheral surface of the honeycomb structure 1 such that the base portion 20 is positioned on an outer side of the electrode layer 11 (an outer side of one of the first and second partial electrode layers 111, 112) in the circumferential direction of the honeycomb structure 1.

The connection portion 21 is a portion that is fixed to the honeycomb structure 1 and electrically connected to the honeycomb structure 1. The connection portion 21 according to the present embodiment is connected to the thermally sprayed underlayer 12 on the electrode layer 11 of the honeycomb structure 1. More specifically, the connection portion 21 is connected to the thermally sprayed underlayer 12 on the first and second partial electrode layers 111, 112.

The connection portion 21 according to the present embodiment has a comb shape having a plurality of teeth portions 23 each extending from the base portion 20. The tooth portions 23 are spaced apart from each other in an extending direction 20E of the base portion 20 and extends from one end of the base portion 20 in a width direction 20W. The extending direction 23E of each tooth portion 23 from the base portion 20 may be the same as the width direction 20W of the base portion 20. The length of each tooth portion 23 extending from the base portion 20 can be equal to or greater than the extending width of the electrode layer 11 in the circumferential direction of the honeycomb structure 1.

The drawer portion 22 is a portion drawn out from the base portion 20. The drawer portion 22 extends from the other end of the base portion 20 in the width direction 20W. The drawer portion 22 may be tongue-shaped as shown in the drawing. The drawer portion 22 is fixed to the honeycomb structure 1 via the base portion 20 and the connection portion 21, and the drawer portion 22 itself may be provided so as to be bendable. An external power source can be connected to the drawer portion 22 via a power cable (not shown).

As described above, the thermally sprayed fixed layers 3 fix the metal electrodes 2 to the honeycomb structure 1. Each of the thermally sprayed fixed layers 3 can be formed by blowing the thermally sprayed material against the outer peripheral surface of the honeycomb structure 1 (the thermally sprayed underlayer 12 or the electrode layer 11) and against each tooth portion 23 while placing the connection portion 21 on the outer peripheral surface of the honeycomb structure 1. Each thermally sprayed fixed layer 3 is provided on the outer peripheral surface of the honeycomb structure 1 (the thermally sprayed underlayer 12 or the electrode layer 11) and on the teeth portion 23 so as to be across each teeth portion 23 in the width direction 23W of the teeth portion 23. The width direction 23W of the tooth portion 23 is a direction orthogonal to an extending direction 23E of the tooth portion 23, which may be the same direction as the extending direction 20E of the base portion 20. As can be particularly seen in FIG. 4, each thermally sprayed underlayer 3 may take a form of a three-dimensional shape having a certain thickness 3T, width 3W and depth 3D. Each thermally sprayed underlayer 3 may have a plurality of surfaces 3a. Each thermally sprayed underlayer 3 may be dome-shaped.

The thermally sprayed fixed layers 3 form the thermally sprayed composite material containing at least one metals and at least one ceramic. The material of the thermally sprayed underlayer 3 may be of the same type as the material of the thermally sprayed underlayer 12. That is, the material of the thermally sprayed fixed layer 3 includes composite materials of metal silicon and silicon carbide, composite materials of a metal silicide such as tantalum silicide and chromium silicide, metal silicon and silicon carbide, and composite materials obtained by adding to one or more metals as described above one or more insulating ceramics such as alumina, mullite, zirconia, cordierite, silicon nitride, bentonite and aluminum nitride, in terms of reducing thermal expansion. The metals that can be used herein, other than the above metals, include heat-resistant metals such as metals containing Al or Cr, SUS, or Ni—Cr alloys, and the like.

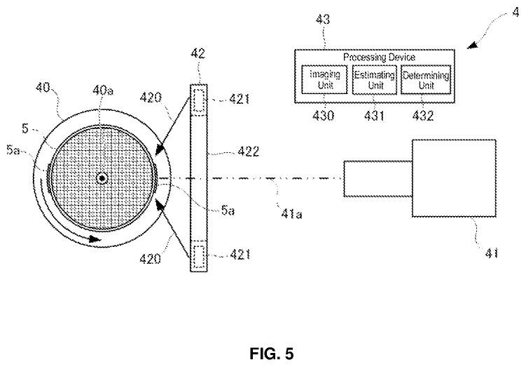

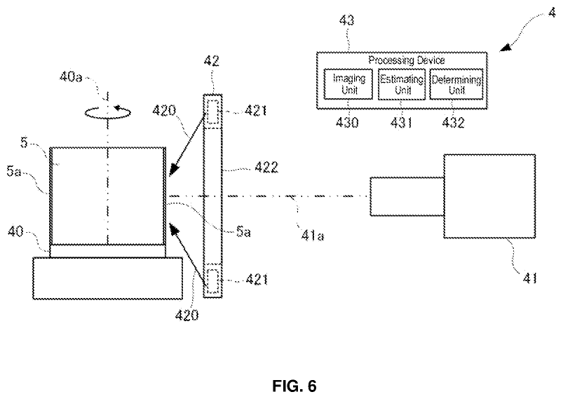

Next, FIG. 5 is a plane view showing an example of an inspection device 4 capable of implementing the method of FIG. 1, and FIG. 6 is a side view showing the inspection device 4 of FIG. 5. The metal ratio inspection method as described above can be implemented using the inspection device 4 shown in FIGS. 5 and 6.

As shown in FIGS. 5 and 6, the inspection device 4 includes a support table 40, an imaging means 41, a light emitting means 42 and a processing device 43.

The support table 40 is a table for supporting a sample 5 having the thermally sprayed composite material 5a to be inspected. The sample 5 is not limited, but it may be the honeycomb structure 1 (see FIG. 2) as described above, or an electrically heating support in which the metal electrodes 2 (see FIG. 3) are fixed to the honeycomb structure 1. That is, the thermally sprayed composite material 5a to be inspected may be the thermally sprayed underlayer 12 or the thermally sprayed fixed layer 3, although not limited thereto.

The imaging means 41 is a device for imaging the thermally sprayed composite material 5a of the sample 5 supported on the support table 40, and can be formed by a device such as a camera, for example. For example, the imaging range of the imaging means 41 may be changed by exchanging imaging lens. Further, the type of the image (still image or moving image) obtained by the imaging means 41 may be changeable. An optical axis 41a of the imaging means 41 is directed toward the thermally sprayed composite material 5a. The imaging means 41 may be arranged such that the optical axis 41a is orthogonal to the outer surface of the thermally sprayed composite material 5a, or arranged such that the optical axis 41a intersects the outer surface of the thermally sprayed composite material 5a at an angle of 90° or less.

The support table 40 and the imaging means 41 may be configured such that the thermally sprayed composite material 5a and/or a portion of the thermally sprayed composite material 5a of the sample 5 imaged by the imaging means 41 can be changed without changing the position of the sample 5. In this embodiment, the support table 40 is configured by a turntable that rotatably supports the sample 5, and the sample 5 is placed on the support table 40 such that the surface of the support table 40 orthogonal to a rotation axis 40a of the support table 40 intersects the thermally sprayed composite material 5a. The rotation axis 40a of the support table 40 is coaxial with the axial direction of the sample 5. The thermally sprayed composite material 5a and/or the portion of the thermally sprayed composite material 5a facing the imaging means 41 is changed by rotating the sample 5 by means of the support table 40. The imaging means 41 may be movably provided around the sample 5.

The support table 40 and the imaging means 41 may be configured to change the thermally sprayed composite material 5a imaged by the imaging means 41 and/or the direction of the thermally sprayed composite material 5a imaged by the imaging means 41, based on relative movement of the support table 40 and the imaging means 41 to each other. The support table 40 and/or the imaging means 41 may be configured such that the height position can be adjusted. The support table 40 and/or the imaging means 41 may be movable in a plane orthogonal to the rotation axis 40a of the support table 40. The imaging means 41 may be configured such that the direction of the optical axis 41a can be adjusted.

The light emitting means 42 is a device for irradiating the thermally sprayed composite material 5a with imaging light 420 when the imaging means 41 images the thermally sprayed composite material 5a. The light emitting means 42 can be arranged to at least partially surround the periphery of the thermally sprayed composite material 5a, although not limited thereto. The light emitting means 42 has a light emitter 421 arranged in an annular shape. The light emitter 421 can be composed of tube lighting, LED light emitting elements, or the like. In the embodiments shown in FIGS. 5 and 6, the annular light emitting means 42 or light emitter 421 is arranged between the imaging means 41 and the thermally sprayed composite material 5a, and the imaging means 41 faces the thermally sprayed composite material 5a through an opening 422 of the light emitting means 42. In the illustrated embodiment, the light emitting means 42 can directly irradiate the thermally sprayed composite material 5a with the imaging light 420 from the light emitter 421 from a position of the surrounding circumference of 360° of the thermally sprayed composite material 5a.

The processing device 43 is a device configured by, for example, a computer or a dedicated circuit. The processing device 43 is connected to the support table 40, the imaging means 41 and the light emitting means 42 by cable or radio wave, and can control the operations of the support table 40, the imaging means 41 and the light emitting means 42. More particularly, the processing device 43 can control the positions of the support table 40 and the imaging means 41, and the rotation operation of the support table 40, the light emission operation of the light emission means 42, the imaging operation of the imaging means 41, and the like. The processing device 43 can acquire an image of the thermally sprayed composite material 5a captured by the imaging means 41 and process the image. The image processing by the processing device 43 may include an estimation process for estimating the metal ratio of the thermally sprayed composite material 5a based on the luminance distribution of the image of the thermally sprayed composite material 5a, and a determination process for determining whether the metal ratio estimated by the estimation process is in a predetermined range.

In other words, the processing device 43 may include: an imaging unit 430 for causing the imaging unit 41 to image the thermally sprayed composite material 5a while irradiating the thermally sprayed composite material 5a with the imaging light 420 from the light emitting means 42; an estimating unit 431 for estimating the metal ratio of the thermally sprayed composite material 5a based on the luminance distribution of the image of the thermally sprayed composite material 5a taken by the imaging unit 41: and a determining unit 432 for determining whether the metal ratio estimated by the estimating unit 431 is in a predetermined range.

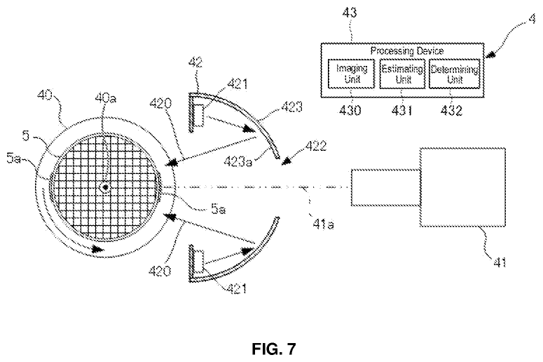

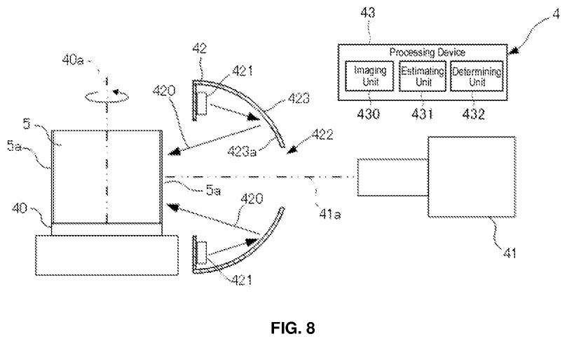

Next, FIG. 7 is a plane view showing a first variant of the inspection device 4 capable of implementing the method of FIG. 1, and FIG. 8 is a side view showing the inspection device 4 of FIG. 7. The metal ratio inspection method as described above can also be implemented using the inspection device 4 as shown in FIGS. 7 and 8. In the inspection device 4 as shown in FIGS. 7 and 8, the irradiation with the imaging light 420 from the light emitter 421 is indirectly performed onto the thermally sprayed composite material 5a through a dome 423. The dome 423 forms a reflecting or diffusing member for reflecting or diffusing the imaging light 420. The dome 423 has a curved, hemispherical or parabolic inner surface 423a. The light emitter 421 is positioned closer to the thermally sprayed composite material 5a than the inner surface 423a of the dome 423. Other structures are the same as those of the inspection device 4 as shown in FIGS. 5 and 6.

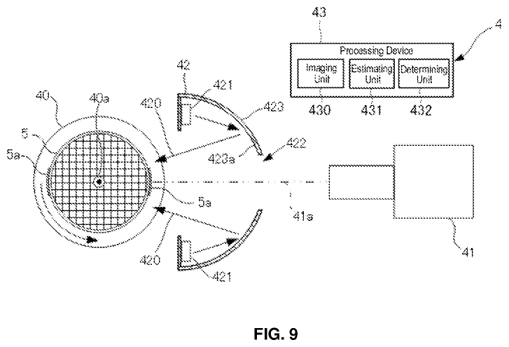

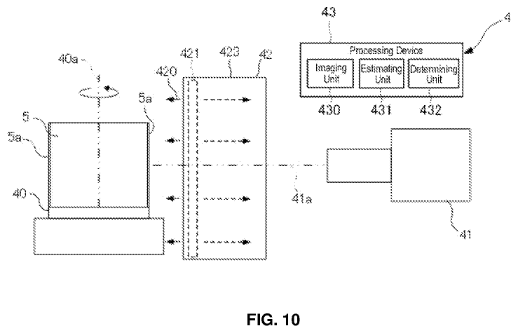

Next, FIG. 9 is a plane view showing a second variation of the inspection device 4 capable of implementing the method of FIG. 1, and FIG. 10 is a side view showing the inspection device 4 of FIG. 9. Although in the embodiments shown in FIGS. 5 to 8, the light emitting means 42 has the light emitter 421 arranged in an annular shape, the shape and/or arrangement of the light emitter 421 can be changed as needed. This is regardless of whether the imaging light 420 is directly or indirectly emitted from the light emitter 421 to the thermally sprayed composite material 5a. In the embodiment shown in FIGS. 9 and 10, a pair of elongated light emitters 421 arranged on opposite sides of the sample 5 are used. Each of the light emitters 421 is arranged such that a length direction of each light emitter 421 extends in the extending direction of the thermally sprayed composite material 5a. When the sample 5 is the honeycomb structure 1 and the honeycomb structure 1 is placed on the support table 40 so that the flow path direction of the cells 101a is along the height direction, each light emitter 421 can be arranged so as to extend in the flow path direction (height direction) of the cells 101a.

Depending on the shapes and/or arrangements of the light emitters 421, the shapes and/or arrangements of features associated with the light emitters 421, such as the dome 423, may also vary as needed. As with the embodiment as shown in FIGS. 7 and 8, in the embodiment as shown in FIGS. 9 and 10, the irradiation with the imaging light 420 from the light emitters 421 is indirectly performed onto the thermally sprayed composite material 5a through the dome 423. In the embodiment as shown in FIGS. 9 and 10, the dome 423 has a shape in which a cylinder is cut in half along its length.

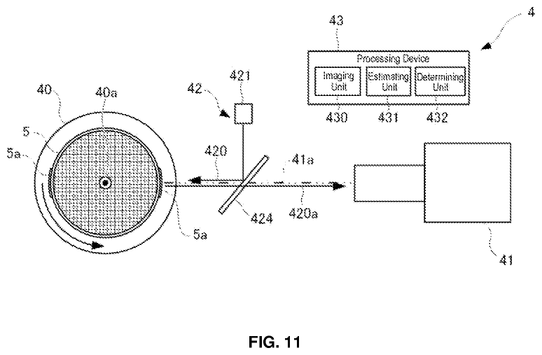

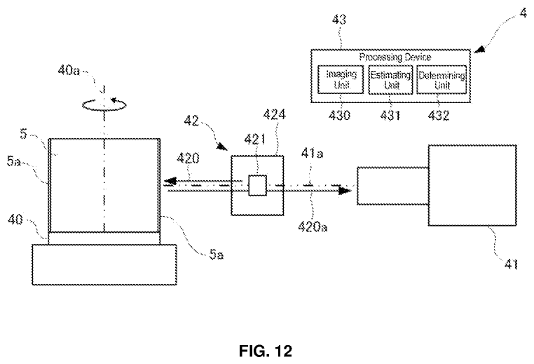

Next, FIG. 11 is a plane view showing a third variation of the inspection device 4 capable of implementing the method of FIG. 1, and FIG. 12 is a side view showing the inspection device 4 of FIG. 11. As shown in FIGS. 11 and 12, the light emitting means 42 may be coaxial episcopic illumination. The light emitting means 42 may have a half mirror 424 arranged on the optical axis 41a of the imaging means 41. The half mirror 424 can reflect the imaging light 420 from the light emitter 421 arranged on the side of the half mirror 424 to irradiate the thermally sprayed composite material 5a along the optical axis 41a. Further, the half mirror 424 can transmit reflected light 420a from the thermally sprayed composite material 5a toward the imaging means 41. In addition, the position of the light emitter 421 is not limited to the side of the half mirror 424, and may be other positions such as above or below the half mirror 424.

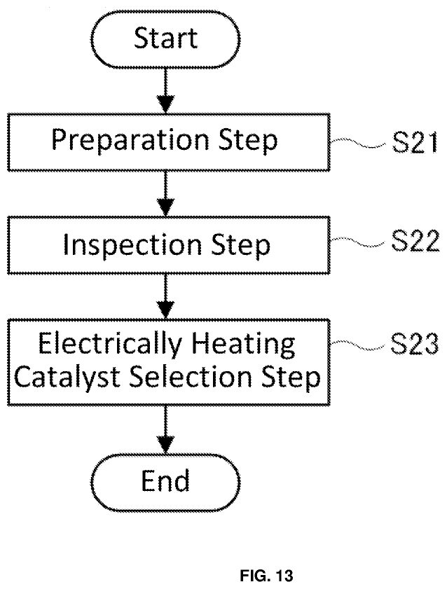

Next, FIG. 13 is a flow chart showing a method for producing an electrically heating catalyst according to an embodiment of the present invention. The method for producing the electrically heating catalyst according to the present embodiment includes a preparation step (step S21), an inspection step (step S22), and an electrically heating catalyst selection step (step S23).

The preparation step (step S21) is a step of preparing an electrically heating catalyst having the metal electrodes 2 fixed by the thermally sprayed fixed layers 3 containing at least one metal and at least one ceramic. This step may be referred to as an electrically heating catalyst preparation step. Each metal electrode 2 may be fixed to the outer peripheral surface of the honeycomb structure 1 by the thermally sprayed fixed layer 3. More specifically, each metal electrode 2 may be fixed to the electrode layer 11 of the honeycomb structure 1. The electrode layer 11 may or may not have a thermally sprayed underlayer 12. When the honeycomb structure 1 has the thermally sprayed underlayers 12, the metal electrodes 2 are fixed to the thermally sprayed underlayers 12. On the other hand, when the honeycomb structure 1 does not have the thermally sprayed underlayer 12, the metal electrodes 2 are fixed to the electrode layers 11.

The inspection step (step S22) is an inspection step for inspecting the metal ratio of the thermally sprayed fixed layer 3 by the above metal ratio inspection method (see FIG. 1) after the preparation step (step S21). In this inspection step, the metal ratio of the thermally sprayed underlayer 3 can be estimated. In the inspection step, it is not necessary to determine whether the metal ratio is in a predetermined range. That is, the inspection step includes the imaging step (step S11) and the estimation step (step S12) of FIG. 1.

The electrically heating catalyst selection step (step S23) is a step of selecting the electrically heating catalyst in which the metal ratio of the thermally sprayed fixed layer 3 is in a predetermined range based on the inspection results of the inspection step. In the electrically heating catalyst selectin step, the electrically heating catalyst having the metal ratio of the thermally sprayed fixed layer 3 in a range of 20 to 80% can be selected. When the metal ratio of the thermally sprayed fixed layer 3 is 20% or more, the strength and conductivity for joining the metal electrodes 2 can be more reliably ensured. When the metal ratio is 80% or less, the thermal expansion of the thermally sprayed fixed layer 3 can be suppressed, and the thermal shock resistance of the thermally sprayed fixed layer 3 can be more reliably ensured. The electrically heating catalyst selected as the metal ratio of the thermally sprayed fixed layer 3 in the predetermined range is sent to the next step. The next step may include shipping. On the other hand, the electrically heating catalyst determined that the metal ratio of the thermally sprayed fixed layer 3 is not in the predetermined range may be repaired or discarded. Although not limited, it can individually determine whether the metal ratios of all of the plurality of thermally sprayed fixed layers 3 are in the predetermined range, and the electrically heating catalyst in which the metal ratios of all of the thermally sprayed fixed layers 3 are in the predetermined range can be selected. Alternatively, it may determine whether the metal ratio of some of the plurality of thermally sprayed fixed layers 3 is in the predetermined range.

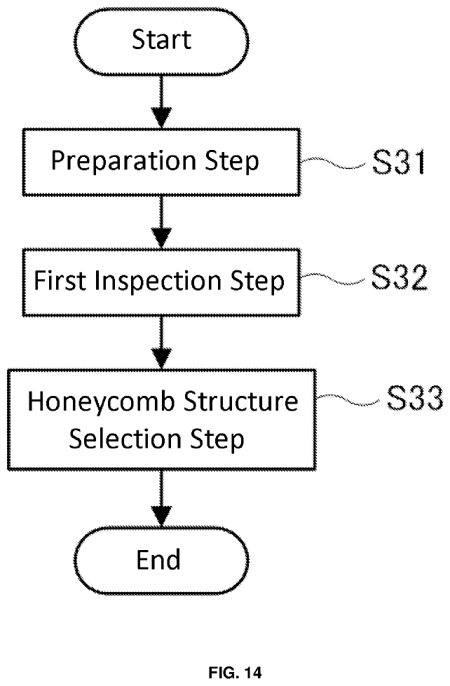

Next, FIG. 14 is a flow chart showing a method for producing a honeycomb structure according to an embodiment of the present invention. The method for producing the honeycomb structure according to the present embodiment includes a preparation step (step S31), a first inspection step (step S32), and a honeycomb structure selection step (step S33).

The preparation step (step S31) is a step of preparing the honeycomb structure 1 having the thermally sprayed underlayer 12 containing at least one metal and at least one ceramic formed on the outer peripheral surface. The step may be referred to as a honeycomb structure preparation step. That is, each electrode layer 11 of the honeycomb structure 1 has the thermally sprayed underlayer 12 in the preparation step in the method for producing the honeycomb structure according to the present embodiment.

The first inspection step (step S32) is an inspection step of inspecting the metal ratio of the thermally sprayed underlayer 12 by the above metal ratio inspection method (see FIG. 1) after the preparation step (step S31). In the inspection step, the metal ratio of the thermally sprayed underlayer 12 can be estimated. In the first inspection step, it may not determine whether the metal ratio is in the predetermined range. That is, the first inspection step includes the imaging step (step S11) and the estimation step (step S12) of FIG. 1.

The honeycomb structure selection step (step S33) is a step of selecting honeycomb structures 1 in which the metal ratio of the thermally sprayed underlayer 12 is in the predetermined range based on the inspection results of the first inspection step. In the honeycomb structure selection step, it can select the honeycomb structure 1 in which the metal ratio of the thermally sprayed underlayer 12 is in the range of 20 to 80%. The metal ratio of the thermally sprayed underlayer 12 of 20% or more can more reliably ensure the electrical conductivity. The metal ratio of 80% or less can suppress the thermal expansion of the thermally sprayed underlayer 12, and more reliably ensure the thermal shock resistance of the thermally sprayed underlayer 12. The honeycomb structure 1 selected as one having the metal ratio of the thermally sprayed underlayer 12 in the predetermined range is sent to the next step. The next step may include a step of fixing the metal electrodes 2 to the honeycomb structure 1 or shipping. On the other hand, the honeycomb structure 1 determined to have the metal ratio of the thermally sprayed underlayer 12 out of the predetermined range may be repaired or discarded. Although not limited, it can individually determine whether the metal ratios of all of the pair of thermally sprayed underlayers 12 are in the predetermined range, and a honeycomb structure 1 in which the metal ratios of all of the thermally sprayed underlayers 12 are in the predetermined range can be selected. Alternatively, it may determine whether the metal ratio is in the predetermined range for one of the pair of thermally sprayed underlayers 12.

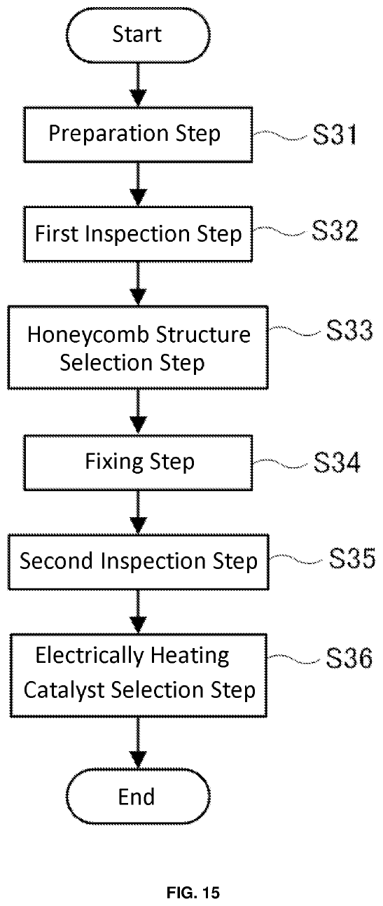

Next, FIG. 15 is a flow chart showing a method for producing an electrically heating catalyst according to an embodiment of the present invention. The method for producing the electrically heating catalyst according to the present embodiment is a method for producing an electrically heating catalyst in which the metal electrodes 2 are fixed to the honeycomb structure 1 obtained by the method for producing the honeycomb structure as described above. The method for producing the electrically heating catalyst according to the present embodiment includes the preparation step (step S31), the first inspection step (step S32), and the honeycomb structure selection step (step S33) as described above, followed by a fixing step (step S34), a second inspection step (step S35), and an electrically heating catalyst selection step (step S36).

The fixing step (step S34) is a step of fixing the metal electrodes 2 to the thermally sprayed underlayers 12 through the thermally sprayed fixed layers 3 containing at least one metal and at least one ceramic in the selected honeycomb structure 1 after the honeycomb structure selection step. The selected honeycomb structure 1 may be a honeycomb structure 1 in which the metal ratio of the thermally sprayed underlayer 12 is in the range of 20 to 80%.

The second inspection step (step S35) is a step of inspecting the metal ratio of the thermally sprayed fixed layer 3 by the above metal ratio inspection method (see FIG. 1) after the fixing step (step S34). In the second inspection step, the metal ratio of the thermally sprayed underlayer 3 can be estimated. In the second inspection step, it is not necessary to determine whether the metal ratio is in the predetermined range. That is, the second inspection step includes the imaging step (step S11) and the estimation step (step S12) of FIG. 1.

The electrically heating catalyst selection step (step S36) is a step of selecting an electrically heating catalyst having a metal ratio of the thermally sprayed fixed layer 3 in a predetermined range based on the inspection results of the second inspection step. In the electrically heating catalyst selection step, an electrically heating catalyst in which the metal ratio of the thermally sprayed fixed layer 3 is in the range of 20 to 80% can be selected. The electrically heating catalyst selected as one having the metal ratio of the thermally sprayed fixed layer 3 in the predetermined range is sent to the next step. The next step may include shipping. On the other hand, the electrically heating catalyst determined to have the metal ratio of the thermally sprayed fixed layer 3 out of the predetermined range may be repaired or discarded.

According to an embodiment of the metal ratio inspection method, the method for producing the electrically heating catalyst and method for producing the honeycomb structure as described above, the metal ratio of the thermally sprayed composite material can be more easily inspected than the case of using the SEM. They can recognize features with a simple principle, as compared with the case of using the SEM. Moreover, the metal ratio of the thermally sprayed composite material 5a (the thermally sprayed underlayer 12 and/or the thermally sprayed fixed layer 3) can be estimated in a non-destructive manner. Moreover, the inspection time (including operations before and after) can be shortened as compared with the case of using the SEM. Further, the selectivity of the observation range to be inspected can be improved (optional switching is possible for one thermally sprayed composite material 5a to be inspected, a plurality of thermally sprayed composite materials 5a to be inspected at the same time, or some thermally sprayed composite materials 5a to be inspected or the entire thermally sprayed composite material 5a to be inspected).

While the preferred embodiments of the present invention have been described in detail above with reference to the drawings, the present invention is not limited to such embodiments. It is obvious that one of ordinary skill in the art to which the present invention belongs can arrive at various variations or modifications in the scope of the technical idea recited in the claims, and they are also understood to belong to the technical scope of the present invention.

### DESCRIPTION OF REFERENCE NUMERALS

1: honeycomb structure
2: metal electrode
3: thermally sprayed fixed layer
5a: thermally sprayed composite material
12: thermally sprayed underlayer
420: imaging light

1. A metal ratio inspection method for inspecting a metal ratio of a thermally sprayed composite material comprising at least one metal and at least one ceramic, the method comprising:
an imaging step of imaging the thermally sprayed composite material while irradiating the thermally sprayed composite material with imaging light; and
an estimating step of estimating a metal ratio of the thermally sprayed composite material based on a luminance distribution of the image of the thermally sprayed composite material obtained in the imaging step.

2. The metal ratio inspection method according to claim 1, wherein in the imaging step, an irradiation angle of the imaging light to the thermally sprayed composite material is 30° to 90°.

3. The metal ratio inspection method according to claim 1, wherein an illuminance of the imaging light is 750,000 lux to 1,500,000 lux in the imaging step.

4. The metal ratio inspection method according to claim 1, wherein the thermally sprayed composite material comprises thermally sprayed fixed layers for fixing metal electrodes to the honeycomb structure.

5. The metal ratio inspection method according to claim 1, wherein the thermally sprayed composite material comprises thermally sprayed underlayers formed on an outer peripheral surface of a honeycomb structure.

6. The metal ratio inspection method according to claim 1, wherein the metal ratio inspection method further comprises a determination step of determining whether the metal ratio estimated in the estimation step is in a predetermined range.

7. A method for producing an electrically heating catalyst, the method comprising:
a preparation step of preparing an electrically heating catalyst having metal electrodes fixed by thermally sprayed fixed layers comprising at least one metal and at least one ceramic;
an inspection step of inspecting the metal ratio of the thermally sprayed fixed layer by the metal ratio inspection method according to claim 1; and
an electrically heating catalyst selection step of selecting an electrically heating catalyst having a metal ratio of the thermally sprayed fixed layer in a predetermined range based on inspection results of the inspection step.

8. A method for producing a honeycomb structure, the method comprising:
a preparation step of preparing a honeycomb structure, the honeycomb structure having thermally sprayed underlayers comprising at least one metal and at least one ceramic, each of the thermally sprayed underlayer being formed on an outer peripheral surface of the honeycomb structure;
a first inspection step of inspecting a metal ratio of the thermally sprayed underlayer by the metal ratio inspection method according to claim 1; and
a honeycomb structure selection step of selecting a honeycomb structure having a metal ratio of the thermally sprayed underlayer in a predetermined range based on inspection results of the first inspection step.

9. The method for producing a honeycomb structure according to claim 8, wherein the honeycomb structure selection step comprises selecting a honeycomb structure having a metal ratio of the thermally sprayed underlayer in a range of 20 to 80%.

10. A method for producing an electrically heating catalyst, the electrically heating catalyst having metal electrodes fixed onto a honeycomb structure obtained by a method for producing the honeycomb structure, the method for producing the honeycomb structure comprising: a preparation step of preparing a honeycomb structure having thermally sprayed underlayers comprising at least one metal and at least one ceramic, each of the thermally sprayed underlayers being formed on an outer peripheral surface of the honeycomb structure; a first inspection step of inspecting a metal ratio of the thermally sprayed underlayer; a honeycomb structure selection step of selecting a honeycomb structure having a metal ratio of the thermally sprayed underlayer in a predetermined range based on inspection results of the first inspection step,
wherein the method for producing an electrically heating catalyst comprises:
a fixing step of fixing the metal electrodes to the thermally sprayed underlayers by thermally sprayed fixed layers comprising at least one metal and at least one ceramic in the selected honeycomb structure after the honeycomb structure selection step;
a second inspection step of inspecting the metal ratio of the thermally sprayed fixed layer; and
an electrically heating catalyst selection step of selecting an electrically heating catalyst having a metal ratio of the thermally sprayed fixed layer in a predetermined range based on inspection results of the second inspection step, and
wherein the first and second inspection steps are performed by the metal ratio inspection method according to claim 1.

11. The method for producing an electrically heating catalyst according to claim 7, wherein the electrically heating catalyst selection step comprises selecting an electrically heating catalyst having a metal ratio of the thermally sprayed fixed layer in a range of 20 to 80%.

12. The method for producing an electrically heating catalyst according to claim 10, wherein the electrically heating catalyst selection step comprises selecting the electrically heating catalyst having a metal ratio of the thermally sprayed fixed layer in a range of 20 to 80%.
